(19) United States
(12) Patent Application Publication
(10) Pub. No.: US 2025/0053761 A1
(43) Pub. Date: Feb. 13, 2025

(54) Devices, Systems, and Methods for Processing Indicia on Different Types of Media

(71) Applicant: ZEBRA TECHNOLOGIES CORPORATION, Lincolnshire, IL (US)

(72) Inventors: Askold V. Strat, Sound Beach, NY (US); Eugene B. Joseph, Coram, NY (US); Miroslav Trajkovic, Setauket, NY (US)

(21) Appl. No.: 18/545,995

(22) Filed: Dec. 19, 2023

Related U.S. Application Data
(60) Provisional application No. 63/532,062, filed on Aug. 10, 2023.

(51) Int. Cl. G06K 7/10; G06K 7/14

(52) U.S. Cl. CPC G06K 7/10732; G06K 7/1473; G06K 7/1486

(57) ABSTRACT

Concepts described herein described herein relate to the determination of media that is presented to indicia readers for digital reading of said indicia. In some cases, embodiments described herein rely on operating an imaging reader in a particular mode of operation where image frames are captured with the intensity of the illumination light varying during said capture and subsequently determining, by analyzing those frame, a media type appearing within the FOV based on one of (i) a lack of an optical signature associated with varying the intensity of the illumination light during the capture of the frame or (ii) a presence of the optical signature associated with the varying the intensity of the illumination light during the capture of the frame.

### CROSS-REFERENCE TO RELATED APPLICATIONS

The current application claims priority from a provisional U.S. Patent Application Ser. No. 63/532,062, filed on Aug. 10, 2023, and incorporated herein by reference in its entirety.

### BACKGROUND

In recent years, in many applications, electronic tickets on cell phones have gained significant popularity alongside the tradition paper-printed tickets. As both types of media are used, the ticket scanners, which are typically tasked with reading and decoding some type of indicia presented on the ticket, need to perform reliably regardless of factors like the print quality on paper or the cell phone display brightness. In certain implementations it is useful to differentiate between a paper-printed and an electronic ticket. Thus, there is a need for devices, systems, and method which help differentiate between media types during the processing of an indicia.

### SUMMARY

Accordingly, the present disclosure presents various embodiments of devices, systems, and method which help differentiate between media types during the processing of an indicia.

In an embodiment, the present invention is an imaging apparatus that comprises: an imaging assembly configured to capture image frames via a rolling shutter imaging sensor; an illumination assembly configured to emit illumination light over at least a portion of a field of view (FOV) of the imaging assembly; and a controller configured to: cause the imaging apparatus to operate in a first mode where during the first mode the imaging assembly captures a first-mode frame such that an intensity of the illumination light varies during a capture of the first-mode frame; and determine, by analyzing the first-mode frame, a media type appearing within the FOV of the imaging assembly based on one of (i) a lack, in the first-mode frame, of an optical signature associated with varying the intensity of the illumination light during the capture of the first-mode frame or (ii) a presence, in the first-mode frame, of the optical signature associated with the varying the intensity of the illumination light during the capture of the first-mode frame.

In another embodiment, the present invention is a method for operating an imaging device having an imaging assembly configured to capture image frames via a rolling shutter imaging sensor and an illumination assembly configured to emit illumination light over at least a portion of a FOV of the imaging assembly, comprising: operating, the imaging apparatus, in a first mode where during the first mode the imaging assembly captures a first-mode frame such that an intensity of the illumination light varies during a capture of the first-mode frame; and determining, by analyzing the first-mode frame, a media type appearing within the FOV of the imaging assembly based on one of (i) a lack, in the first-mode frame, of an optical signature associated with varying the intensity of the illumination light during the capture of the first-mode frame or (ii) a presence, in the first-mode frame, of the optical signature associated with the varying the intensity of the illumination light during the capture of the first-mode frame

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective front and back view of an optical imaging reader in accordance with various embodiments of the present disclosure.

FIG. 2 illustrates a perspective front view of another optical imaging reader in accordance with various embodiments of the present disclosure.

FIG. 3 illustrates a perspective front view of another optical imaging reader in a form of a mobile device in accordance with various embodiments of the present disclosure.

FIG. 4 illustrates a schematic block diagram of various components of an example imaging apparatus in accordance with various embodiments of the present disclosure.

FIG. 5 is an example representation of an operation of a rolling shutter sensor.

FIG. 6 is an example image capturing an indicium printed on paper with the reader operating in the first mode of operation.

FIG. 7 is an example image capturing an indicium displayed on a cell phone screen with the reader operating in the first mode of operation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

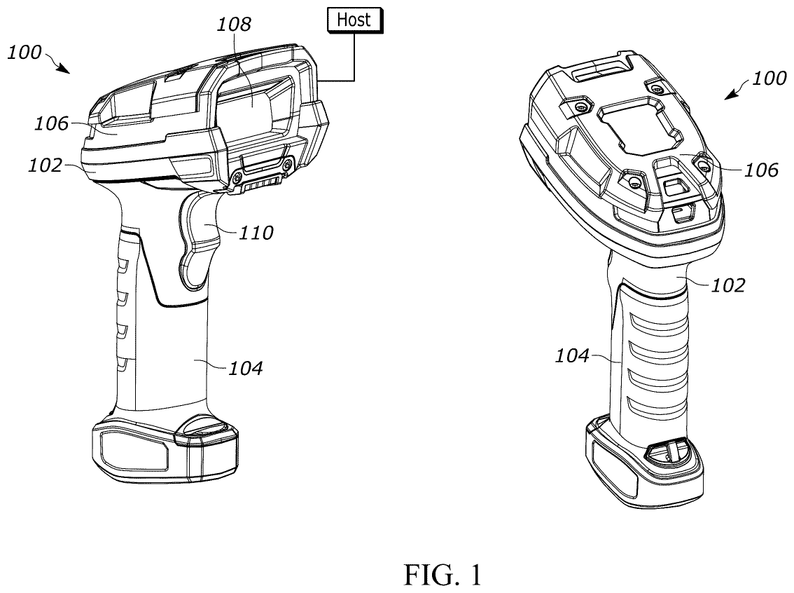

Referring to FIG. 1, shows therein is an exemplary embodiment of an optical imaging reader 100 (also referred to as a barcode reader or indicia reader) and the components thereof. The reader 100 includes a housing 102 with a handle portion 104, also referred to as a handle 104, and a head portion 106, also referred to as a scanning head 106. The head portion 106, which is positioned on the top of the handle portion 104, includes an imaging assembly positioned therein and a window 108. The handle portion 104 is configured to be gripped by an operator (not shown) and includes a trigger 110 for activation by the operator. Optionally included in an embodiment is also a base (not shown), also referred to as a base portion, that may be attached to the handle portion 104 opposite the head portion 106, and be configured to stand on a surface and support the housing 102 in a generally upright position. The barcode reader 100 can be used in a hands-free mode as a stationary workstation when it is placed on a countertop or other workstation surface. The barcode reader 100 can also be used in a handheld mode when it is picked up off the countertop or base station, and held in an operator's hand. In the hands-free mode, items can be slid, swiped past, or presented to the window 108 for the reader to initiate indicia-reading operations. In the handheld mode, the barcode reader 100 can be moved towards a barcode on a product, and the trigger 110 can be manually depressed to initiate imaging of the barcode.

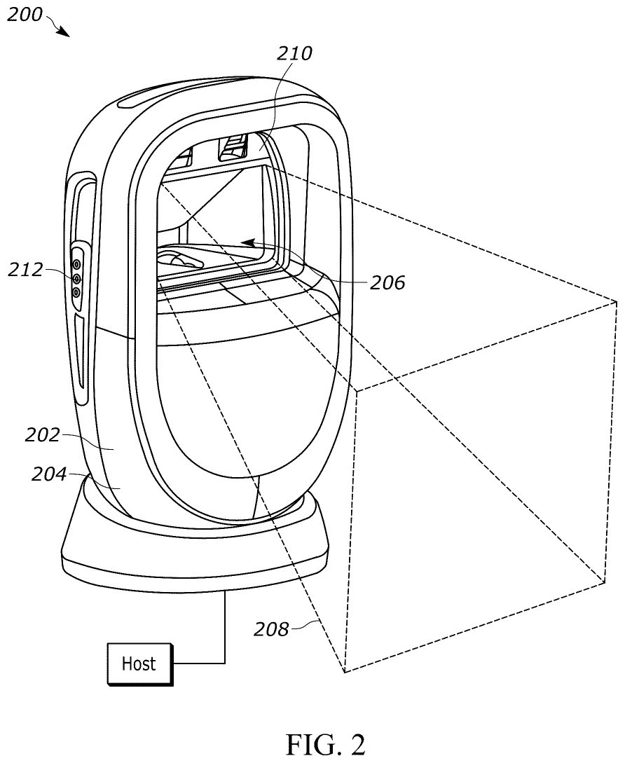

Another embodiment of an optical imaging reader in accordance with the teachings of this disclosure is illustrated in FIG. 2. The reader 200 may be referred to as an indicia reader, and the reader device may be handheld to move around a target to scan indicia or the reader 200 may be stationary, for example, free standing on a countertop. In the example shown, the reader 200 includes a housing 202 having a lower housing portion 204 and an optical imaging assembly 206. The optical imaging assembly 206 is at least partially positioned within the housing 202 and has a FOV 208. The reader 200 also includes an optically transmissive window 210 and a trigger 212.

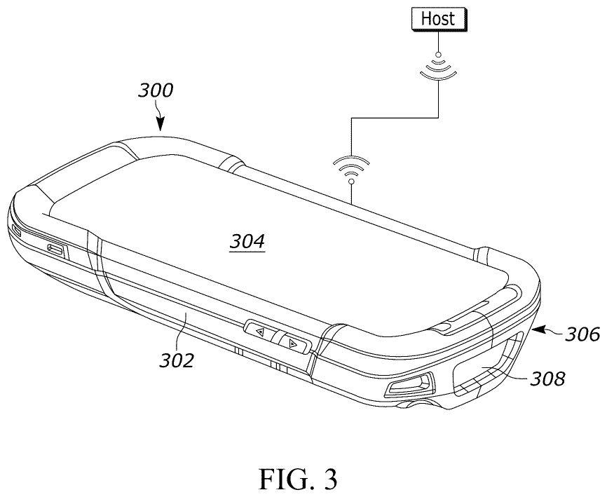

Another embodiment of an optical imaging reader in accordance with the teachings of this disclosure is illustrated in FIG. 3. In this embodiment, the imaging reader is embodied in a mobile computing device 300. Mobile device 300 includes a housing 302 supporting various other components of the device 300. Among the components supported by the housing 302 are a display 304 that, in the illustrated example, also includes an integrated touch screen. The housing 302 can also support a data capture module 306 like the imaging reader of the various embodiments described herein. This data capture module 306 is positioned behind the window 308 through which the module 306 can capture images and/or illumination to detect and decode indicia such as barcodes affixed to objects within the module's FOV.

Generally speaking, the form factors provided in FIGS. 1-3 are merely exemplary and the teaching of the present disclosure may be applied to imaging readers (otherwise referred to as imaging apparatuses) regardless of their physical configuration. For example, the teachings described herein may be implemented in devices like bi-optic indicia readers, slot scanners, imaging engines, machine vision cameras, and so on.

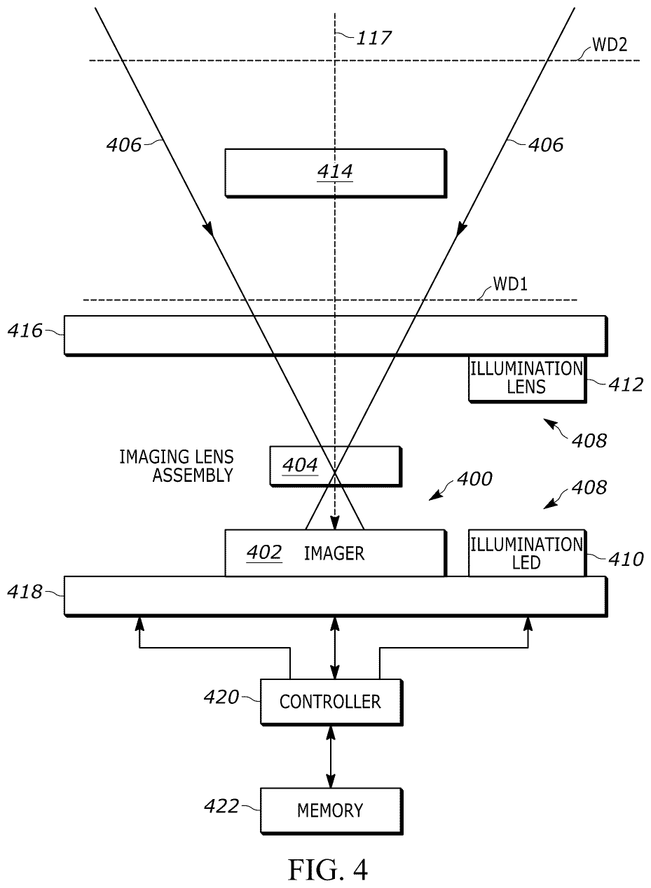

As shown in the schematic block diagram of various components of an example imaging apparatus of FIG. 4, these devices generally include an optical imaging assembly 400 that itself includes a rolling shutter image sensor 402 (also referred to as an imaging sensor or imager) together with an imaging lens assembly 404 that focuses and directs light over a predefined field of view (FOV) 406 onto the image sensor 402. To help capture images of sufficient quality, the imaging devices are further equipped with an illumination assembly 408 which commonly include an illumination source 410 and an illumination lens 412. The illumination source may be implemented as any source (like an LED source) operative to produce light that can illuminate an appropriate portion of the FOV 406 and provide sufficient light during image capture. In this manner, at least some light emitted by the illumination source away from the imaging apparatus will reflect off an object 414 being imaged and will be reflected by said object onto the imager 402, helping create a sufficiently illuminated image for various purposes, like indicia decoding. Additionally, the illumination source may be controlled to operate in accordance with various operating characteristics, particularly as outlined further in this disclosure.

These imaging components are typically housed in some type of a housing (like, for example, examples of FIGS. 1-3) behind a window 416 and operate over some working range defined by a near working range WD1 and a far working range WD2. Range limits WD1 and WD2 may depend on the focusing capabilities of the imaging optics, the resolution of the image sensor, and/or the illumination characteristics.

The imaging assembly 400 and illumination assembly 410 may be positioned on same (or separate) printed circuit board 418 and each one may be controlled via a controller 420 which is operatively connected to at least some components of each assembly. Controller 420 may be embodied in one or more microprocessors that includes one or more modules for conducting the control functions associated with the imaging apparatus. It should be appreciated that while the controller is illustrated as a single element 420 in the block diagram of FIG. 4, its functional components may be separated over multiple physical processors in communication with each other such that, in combination, these components provide the necessary functionality of the imaging sensor 402 and the illumination source 410, along with the appropriate processing of image data, as disclosed further herein. The imaging apparatus further includes a memory 422 for storing instruction that, when executed by the controller 420 cause the imaging apparatus, or various components thereof, to perform in a particular manner. Furthermore, common additional components like a decode module to analyze image data and to detect and decode indicum therein, an aimer assembly may also be implemented in the imaging apparatus and said apparatuses may be connected with their respective hosts such that data, like a payload of a decoded barcode, may be transmitted thereto.

Returning to the image sensor 402, it may be implemented as, for example, a two-dimensional CCD or a CMOS sensor that can be either a monochrome sensor or a color sensor having, for instance 1.2 megapixels arranged in a 1200×960 pixel configuration. It should be appreciated that sensors having other pixel-counts (both below and above) are within the scope of this disclosure. These two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through the window of the reader.

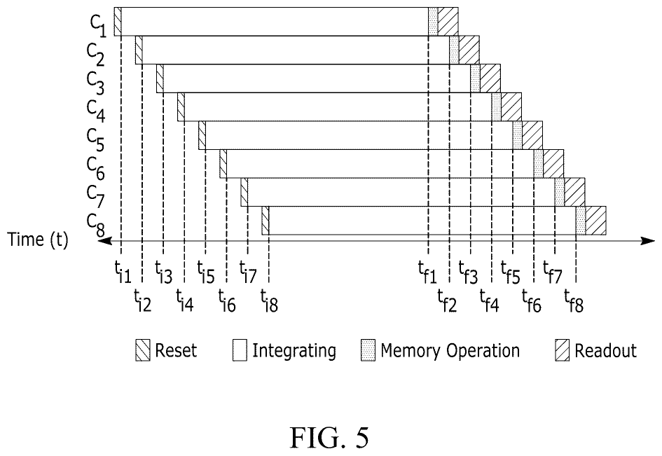

In particular, the sensor 420 is implemented as a sensor having a rolling shutter by exposing one or a series of rows of pixels at a time. FIG. 5 provides a general overview of a sensor operating with a rolling shutter and illustrates the exposure of a series of rows C₁-C₈ over one image frame. While the figure is described with respect to the activation of series of rows, it will be appreciated that the same operational approach applies to the activation of individual rows.

Considering the earliest time illustrated in the figure, a controller, like controller 420, first reset the series of rows of pixels C₁, and at a time ti the series of rows of pixels C₁ detect optical radiation, generate an electrical signal indicative of the detected radiation, and begin integrating the electrical signal. At a time subsequent to tᵢ₁, the controller resets the second series of rows of pixels C₂, and at a time tᵢ₂ the series of rows of pixels C₂ begin detecting optical radiation, generate an electrical signal indicative of the radiation, and integrate the electrical signal. Subsequent pixel row series C₃-C₈ are each independently reset, and activated at respective times tis to tis, to detect radiation, generate electrical signals, and integrate according to the pre-described pattern.

After the first series of rows of pixels C₁ has integrated the electrical signals of detected radiation, the controller 420 deactivates the first series of rows at time to and the integrated signals are stored in a memory, like the memory 422. In this manner, each of the second through eighth series of rows of pixels C₂-C₈ is also deactivated at respective times t_{f2}-t_{f8} and each series of rows of pixels C₂-C₈ stores corresponding integrated signals in memory. It will be appreciated that the timing delay in the activation of each of the series of rows of pixels is illustrated in an exemplary manner and this delay may be longer or shorter. Additionally, while there is a region between tis and tn where all rows of pixels are active, depending on when each of the series of rows of pixels is activated it is conceivable that such window will not exist and there will not be a timeframe when all rows of the sensor will be active. The stored data forms the image data of a given frame that is captured by image sensor and this data may be provided to various modules of the controller/imaging apparatus for further processing and/or analysis, in accordance with various teachings of the present disclosure.

It has been found that the operation of a rolling shutter sensor may be leveraged to help identify a particular media on which an indicium is being provided on. As used herein, indicium, should be interpreted as any visual feature that can be used to perform operations associated therewith. For example, an indicium may be a visual feature that can encode a payload whereby a decoding analysis of such indicium would reveal the encoded payload. In such cases, an indicium may be embodied in a 1D barcodes or 2D barcodes like QR codes, data-matrix, etc. In other instances, an indicium may be a visual logo used for authentication, like a hologram, or any other visual marker.

While it should not be viewed as limiting, of particular interest in this disclosure is the ability to discern indicia printed on a physical medium, like paper, plastic, cardboard, etc., and digital media like a screen of a mobile phone, a screen of a tablet, or a screen of a laptop. A particular differentiator between these two groups if the fact that unlike the print produced on a physical media which generally does not generate illumination, visual elements displayed on a display of an electronic device are provided through the illumination of various pixels on that screen. For example, a cellphone screen is visible in the dark due to its own source of illumination. This is because for most technologies used in cellphone displays there is a backlight that illuminates the screen, and external ambient light has little or no influence on the brightness of the screen for purposes of image capture. Conversely, media like paper needs a source of illumination to be visible.

This leads to the understanding that for paper tickets to be readable by a camera-based imaging apparatus, it is necessary to have sufficient ambient illumination or for the camera to be equipped with a light source. Typical imaging apparatuses like barcode readers use LEDs for this purpose, which are lit up during the image capture, to ensure sufficient brightness for decoding the images. For a cell phone display the illumination does not help increase the acquired image brightness as sufficient light is generated by the display. For this reason, an image captured with the illumination on will typically have a substantially same brightness as an image with the engine illumination off.

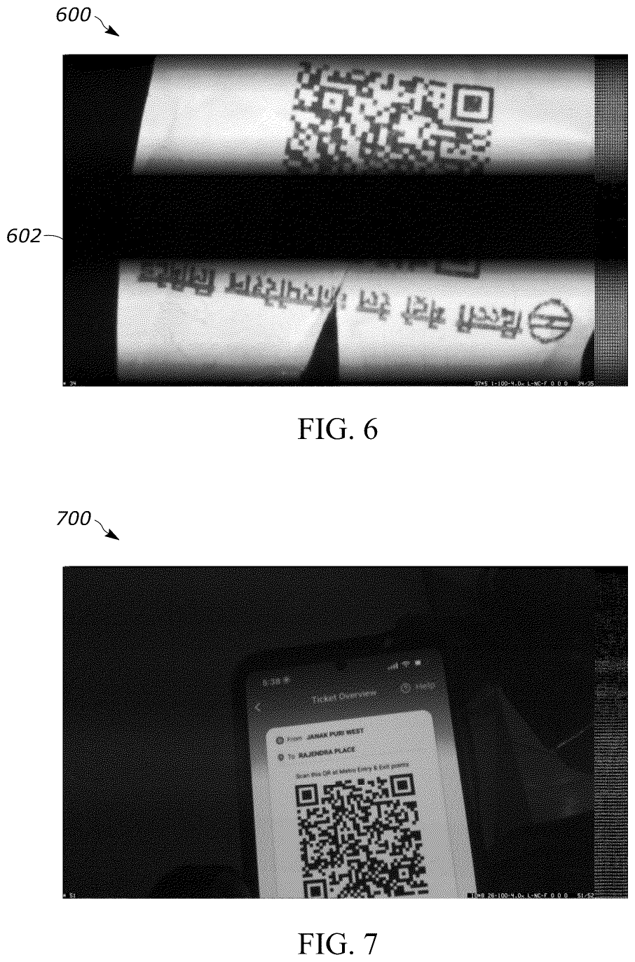

Separate from this, if the illumination brightness varies during the time of image capture of a rolling shutter sensor, the brightness of the captured image will vary accordingly, and some rows of pixels will be brighter than others, depending on the position of the slot with respect to the illumination brightness. For example, FIG. 6 illustrates the effect of illumination brightness variation on paper media for a rolling shutter sensor. The unilluminated region 602 of the image 600 results from reducing or turning off the illumination during a portion of the time that the frame is captured. This effect is not visible for a cellphone screen, as shown in image 700 of FIG. 7. Relying on this, it is possible to differentiate the type of media on which an indication is printed/displayed on (e.g., paper versus a screen that provides its own illumination like a cellphone screen).

Taking an example associated with decoding an indicium, during a decode session a reader collects images for the purpose of decoding. These images, also referred to as frames, are acquired with different settings, such as exposure time, gain, and/or illumination, in order maximize the quality required for decoding. The reader may be configured to have a pre-defined sequence of frame types which it can cycle through during the acquisition process. The decoder analyzes these frames and decodes barcodes that may be present therein when possible. The reader then typically indicates a good decode by a short beep and/or an LED flash, while sending the decode data to the host.

The shutter effect on the paper media, which appears as horizontal stripe(s) 602 in FIG. 6, can be obtained by adjusting the image acquisition settings appropriately. This can include adjusting the illumination such that it is cycled during the frame integration, which, in some embodiments, can be approximately 30 ms for a rolling shutter sensor. The thickness of the dark band in the image is proportional to the time that the illumination is off and relative to the 30 ms frame time. For instance, exemplarily mapping the image 600 to the operation of a rolling shutter sensor illustrated in FIG. 5, illumination would be active between times tᵢ₁ and tᵢ₄, and also between t_{f6} and t_{f8}. Conversely, illumination would be inactive between the times tᵢ₄ and t_{f6}. By structuring the illumination assembly to operate in this manner, series of rows of pixels C₄-C₆ would be active when the illumination is off (or reduced), and the resulting image would reflect this by having the dark band 602.

When the reader is operating pursuant to such illumination-variable image capture scheme, it may be viewed as operating in a first mode, capturing one or more frames while varying the illumination intensity during each of those frames. In some cases, this variance may be between a relatively higher and a relatively lower intensity. In other cases, this may include alternating between providing illumination and turning the illumination off altogether.

Asides from the frames captured the during the first mode of operation the reader is configured to acquire other frame types with the illumination on. In these cases, the illumination remains substantially constant during the capture of the frames. In some embodiments a substantially constant illumination means a variance in intensity of less than 1%, 5%, 10%, 20%, 30%, or 40% over the duration of the frame capture. Capturing these frames may be seen as operating in a second mode of operation. Typically, these frames provide sufficient contrast and brightness especially for paper media, so that barcodes printed thereon can be decoded.

As the reader cycles through modes acquiring different frame types, the controller analyses the frames captured by in the first mode of operation and based on the presence or absence of the stripe determines if the media is paper or cellphone screen, respectively. Preferably, only images without the stripe are passed to the decoder, as the presence of a stripe is likely to interfere with the indicia making it undecodable.

Provided that the reader can differentiate between paper and backlit display (like that of a cellphone), it can augment the transmission of a decoded payload to a host with data that is associated with the detected media type. For example, the transmission can append a ‘0’ or a ‘1’ respectively to the decode string. This indicator may be implemented as a byte variable by the processing application of the controller. At the beginning of a decode session this byte may be initialized to a different character, to indicate that the media type has not yet been evaluated. Upon encountering a first-mode frame, the controller changes the byte value according to the detected media type. When a decode occurs following the media detection, the media type byte is appended to the decode sting and sent to the host.

If a decode occurs before the media type byte is set to either ‘0’ or ‘1’ then the decode string is saved, but it is not sent until the image controller processes an appropriate frame (frame captured pursuant to the first mode of operation) and determines the media type. Once that is established, the decode data is appended with the media type byte and sent to the host.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging apparatus, comprising:
an imaging assembly configured to capture image frames via a rolling shutter imaging sensor;
an illumination assembly configured to emit illumination light over at least a portion of a field of view (FOV) of the imaging assembly; and
a controller configured to:
cause the imaging apparatus to operate in a first mode where during the first mode the imaging assembly captures a first-mode frame such that an intensity of the illumination light varies during a capture of the first-mode frame; and
determine, by analyzing the first-mode frame, a media type appearing within the FOV of the imaging assembly based on one of (i) a lack, in the first-mode frame, of an optical signature associated with varying the intensity of the illumination light during the capture of the first-mode frame or (ii) a presence, in the first-mode frame, of the optical signature associated with the varying the intensity of the illumination light during the capture of the first-mode frame.

2. The imaging apparatus of claim 1, wherein the controller is further configured to, responsive to decoding, by a decoding module, an indicium within the first-mode frame, augment a transmission of a payload of the indicia to a host with data associated with a determined media type.

3. The imaging apparatus of claim 1, wherein the controller is further configured to:
cause the imaging apparatus to operate in a second mode where during the second mode the imaging assembly captures a second-mode frame such that the intensity of the illumination light remains substantially constant during a capture of the second-mode frame; and
responsive to decoding, by a decoding module, an indicium within at least one of the first-mode frame or the second-mode frame, augment a transmission of a payload of the indicia to a host with data associated with a determined media type.

4. The imaging apparatus of claim 3, wherein the controller is further configured to:
alternate between causing the imaging apparatus to operate in the first mode and causing the imaging apparatus to operate in the second mode upon an initiation of an indicia-reading session and until one of a successful decode of an indicium or a timeout event resulting from no successful decode.

5. The imaging apparatus of claim 3, wherein the controller is further configured to:
cause the imaging apparatus to operate in the second mode to capture the second-mode frame prior to causing the imaging apparatus to operate in the first mode to capture the first-mode frame; and
responsive to decoding, by the decoding module, the indicium in the second-mode frame, delaying the transmission of the payload of the indicia to the host until the controller determines the media type by analyzing the first-mode frame.

6. The imaging apparatus of claim 1, wherein the optical signature associated with the varying the intensity of the illumination light is associated with a band of relatively darker pixels within the first-mode frame as compared to pixels within other portions of the first-mode frame.

7. The imaging apparatus of claim 1, wherein the optical signature associated with the varying the intensity of the illumination light is associated with a band of pixels within the first-mode frame, wherein the band of pixels is associated with a sufficiently low brightness level.

8. The imaging apparatus of claim 1, wherein the optical signature associated with the varying the intensity of the illumination light is associated with a band of pixels within the first-mode frame, and wherein the band of pixels appears within a region of the first-mode frame that is exposed when the illumination light is emitted at a relative lower intensity as compared to another region of the first-mode frame that is exposed when the illumination light is emitted at a relative higher intensity.

9. The imaging apparatus of claim 1, wherein the intensity of the illumination light varies during the capture of the first-mode frame such that during some portion of the capture of the first-mode frame the illumination assembly emits no illumination light and during some other portion of the capture of the first-mode frame the illumination assembly emits at least some illumination light.

10. The imaging apparatus of claim 1, wherein the intensity of the illumination light varies during the capture of the first-mode frame such that during some portion of the capture of the first-mode frame the illumination assembly emits illumination light at a relatively lower intensity and during some other portion of the capture of the first-mode frame the illumination assembly emits illumination light at a relatively higher intensity.

11. A method for operating an imaging device having an imaging assembly configured to capture image frames via a rolling shutter imaging sensor and an illumination assembly configured to emit illumination light over at least a portion of a field of view (FOV) of the imaging assembly, comprising:
operating, the imaging apparatus, in a first mode where during the first mode the imaging assembly captures a first-mode frame such that an intensity of the illumination light varies during a capture of the first-mode frame; and
determining, by analyzing the first-mode frame, a media type appearing within the FOV of the imaging assembly based on one of (i) a lack, in the first-mode frame, of an optical signature associated with varying the intensity of the illumination light during the capture of the first-mode frame or (ii) a presence, in the first-mode frame, of the optical signature associated with the varying the intensity of the illumination light during the capture of the first-mode frame.

12. The method of claim 11, further comprising, responsive to decoding, by a decoding module, an indicium within the first-mode frame, augmenting a transmission of a payload of the indicia to a host with data associated with a determined media type.

13. The method of claim 11, further comprising:
operating, the imaging apparatus, in a second mode where during the second mode the imaging assembly captures a second-mode frame such that the intensity of the illumination light remains substantially constant during a capture of the second-mode frame; and
responsive to decoding, by a decoding module, an indicium within at least one of the first-mode frame or the second-mode frame, augmenting a transmission of a payload of the indicia to a host with data associated with a determined media type.

14. The method of claim 13, further comprising:
alternating between operating, the imaging apparatus, in the first mode and operating, the imaging apparatus, in the second mode upon an initiation of an indicia-reading session and until one of a successful decode of an indicium or a timeout event resulting from no successful decode.

15. The method of claim 13, further comprising:
operating, the imaging apparatus, in the second mode to capture the second-mode frame prior to causing the imaging apparatus to operate in the first mode to capture the first-mode frame; and
responsive to decoding, by the decoding module, the indicium in the second-mode frame, delaying the transmission of the payload of the indicia to the host until the controller determines the media type by analyzing the first-mode frame.

16. The method of claim 11, wherein the optical signature associated with the varying the intensity of the illumination light is associated with a band of relatively darker pixels within the first-mode frame as compared to pixels within other portions of the first-mode frame.

17. The method of claim 11, wherein the optical signature associated with the varying the intensity of the illumination light is associated with a band of pixels within the first-mode frame, wherein the band of pixels is associated with a sufficiently low brightness level.

18. The method of claim 11, wherein the optical signature associated with the varying the intensity of the illumination light is associated with a band of pixels within the first-mode frame, and wherein the band of pixels appears within a region of the first-mode frame that is exposed when the illumination light is emitted at a relative lower intensity as compared to another region of the first-mode frame that is exposed when the illumination light is emitted at a relative higher intensity.

19. The method of claim 11, wherein the intensity of the illumination light varies during the capture of the first-mode frame such that during some portion of the capture of the first-mode frame the illumination assembly emits no illumination light and during some other portion of the capture of the first-mode frame the illumination assembly emits at least some illumination light.

20. The method of claim 11, wherein the intensity of the illumination light varies during the capture of the first-mode frame such that during some portion of the capture of the first-mode frame the illumination assembly emits illumination light at a relatively lower intensity and during some other portion of the capture of the first-mode frame the illumination assembly emits illumination light at a relatively higher intensity.

21. A tangible machine-readable medium comprising instructions that, when executed, cause an imaging apparatus, having an imaging assembly configured to capture image frames via a rolling shutter imaging sensor and an illumination assembly configured to emit illumination light over at least a portion of a field of view (FOV) of the imaging assembly, to:
operate in a first mode where during the first mode the imaging assembly captures a first-mode frame such that an intensity of the illumination light varies during a capture of the first-mode frame; and
determine, by analyzing the first-mode frame, a media type appearing within the FOV of the imaging assembly based on one of (i) a lack, in the first-mode frame, of an optical signature associated with varying the intensity of the illumination light during the capture of the first-mode frame or (ii) a presence, in the first-mode frame, of the optical signature associated with the varying the intensity of the illumination light during the capture of the first-mode frame.
